(19) United States
(12) Patent Application Publication
(10) Pub. No.: US 2013/0318469 A1
(43) Pub. Date: Nov. 28, 2013

(54) Education Management and Student Motivation System

(71) Applicant: Frank J. Wessels, Staten Island, NY (US)

(72) Inventor: Frank J. Wessels, Staten Island, NY (US)

(21) Appl. No.: 13/479,858

(22) Filed: May 24, 2012

(51) Int. Cl. G06F 3/048; G06F 17/30

(52) U.S. Cl. 715/781; 715/765; 715/840

(57) ABSTRACT

An educational management system is disclosed. The system provides software tools for displaying student grades to a class, easily recording student behavior during lessons, and adjusting student grade output in real time. The system provides students immediate feedback on their behavior, and provides teachers with an integrated grading tool that accurately incorporates student behavior into the final grade.

### CROSS REFERENCES TO RELATED APPLICATIONS

None.

### FIELD OF INVENTION

The technology relates to the field of education software and has particular application to the field of classroom management student motivational software.

### BACKGROUND

Disruptive student behavior and lack of student motivation cause a number of problems. During the traditional “chalk-and-talk” lesson, teachers may attempt to address these problems with verbal warnings or threats of grade reduction. The discipline achieved, if any, is fleeting.

In fact, these verbal warnings can be counterproductive. Many students crave attention, and if they cannot earn positive attention, they will settle for negative attention. When a teacher takes time to address a disruptive student, the lesson loses its flow and rhythm. Formerly attentive students lose interest. There is a need for a system of policing student misbehavior that does not interrupt the lesson or shower attention upon misbehaving students.

Tracking and recording misbehavior is also difficult. Teachers may keep mental notes on disruptive students, but accurate mental accounting is difficult. When grades are recorded at the end of a term, adjustments based on such mental accounting is imprecise, opaque and may seem arbitrary (especially at the margins).

Student Motivation.

Many underperforming students would like to improve, but working towards a distant end-of-semester grade is insufficient motivation. But, when long-term goals are broken down into bite-size chunks, each portion seems achievable. Student motivation may be further improved by immediately visualizing the results of these bite-size achievements.

Student Participation Problem.

When calling on students, teachers may pass over underperforming students in favor of brighter ones. Even though underachievers may benefit more from such interaction, teachers may have an interest in moving lesson forward. To better encourage student participation, there is a need for a system of fairly selecting students for participation.

There is a need for a classroom management system that provides students with feedback that is immediate, visual, audible, and permanent. In addition, teachers must be able to input data in real time, and with minimal effort and distraction.

### SUMMARY

The disclosed software and method provides a tool for incentivizing positive behavior and maintaining a civil classroom atmosphere.

Components.

The disclosed classroom management system displays student achievements in real-time. It provides an intuitive interface for selecting a student and adjusting relevant achievement data. The display uses a space-efficient layout in order to keep screen real estate available for substantive lesson or demonstration purposes.

Teachers may update the displayed data in real time (for example, noting student misbehavior). The system allows teachers to note disruptive student behavior without interrupting a lesson. The disruptive student is receives notice of his infraction from a visual display rather than a verbal warning. Since student assignment and behavior data is updated in real time, students see the immediate affects of their actions.

Parent Communication.

The system provides enhanced communication with parents and other stakeholders. The behavior and educational achievement information logged by the system may be easily shared with parents, counselors and social workers. For example, a parent could receive an email or SMS when their child misbehavior is noted by the system.

Student Accountability.

The system encourages student responsibility by visualizing grade data and explaining grade calculation methods. For example, scores and grades may be color coded to facilitate recognition and patterns at a glance. Missing tests and homework assignments, and their affects on student grades, are conveniently accessible to students.

Participation.

Random student selection or selection based on student performance (low participation score results in student being called more frequently). Since student participation and behavior is tracked in real-time, the system can integrate this information into a weighted algorithm for selecting a student.

Use.

The system allows teachers to roam the classroom, and even stand behind students, during a lecture. In addition to use in lectures, the system is particularly useful during interactive group activities.

### BRIEF DESCRIPTION OF THE DRAWINGS

FIG. 1 illustrates a high-level overview flowchart of a preferred embodiment.

FIG. 2 illustrates a more detailed flowchart of a preferred embodiment.

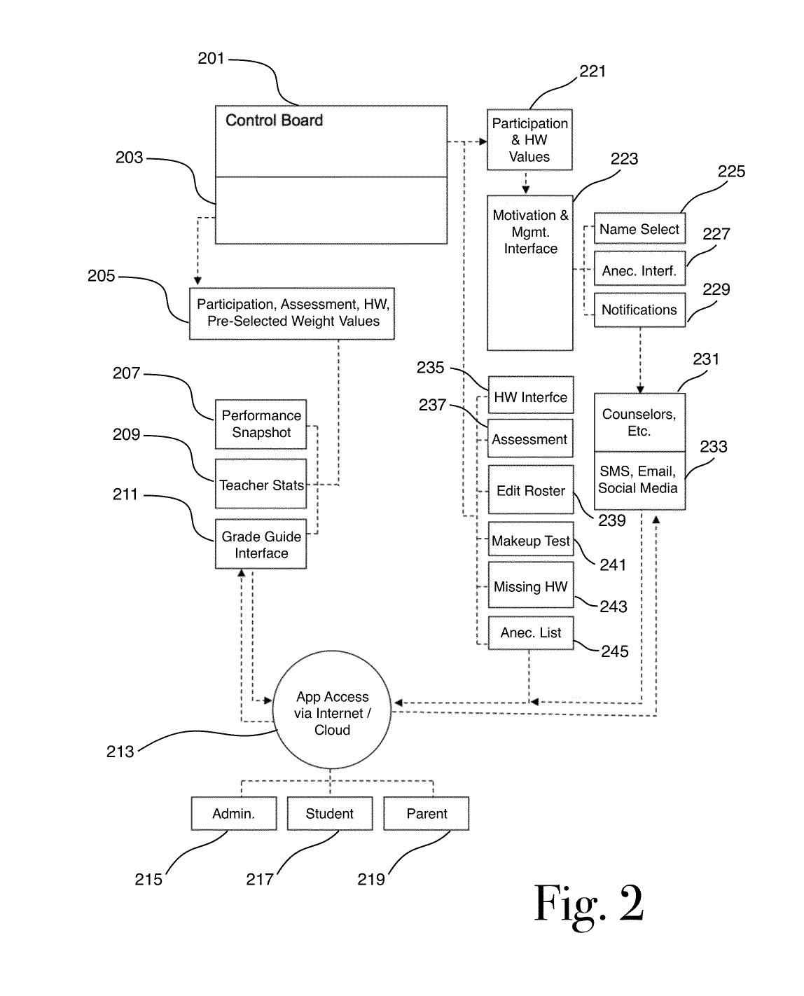

FIG. 3 illustrates an exemplary Control Panel interface.

FIG. 4 illustrates an exemplary Motivation and Management Interface.

FIG. 5 illustrates an exemplary Anecdotal Interface.

FIG. 6 illustrates an exemplary Assessment Interface.

FIG. 7 illustrates an exemplary Homework Interface.

FIG. 8 illustrates an exemplary Name Selector.

FIG. 9 illustrates an exemplary Student Statistical Interface.

### DETAILED DESCRIPTION & PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Overview & System Context

The disclosed software and methods provide tools for incentivizing positive student behavior, recording inappropriate student behavior and maintaining a civil classroom atmosphere.

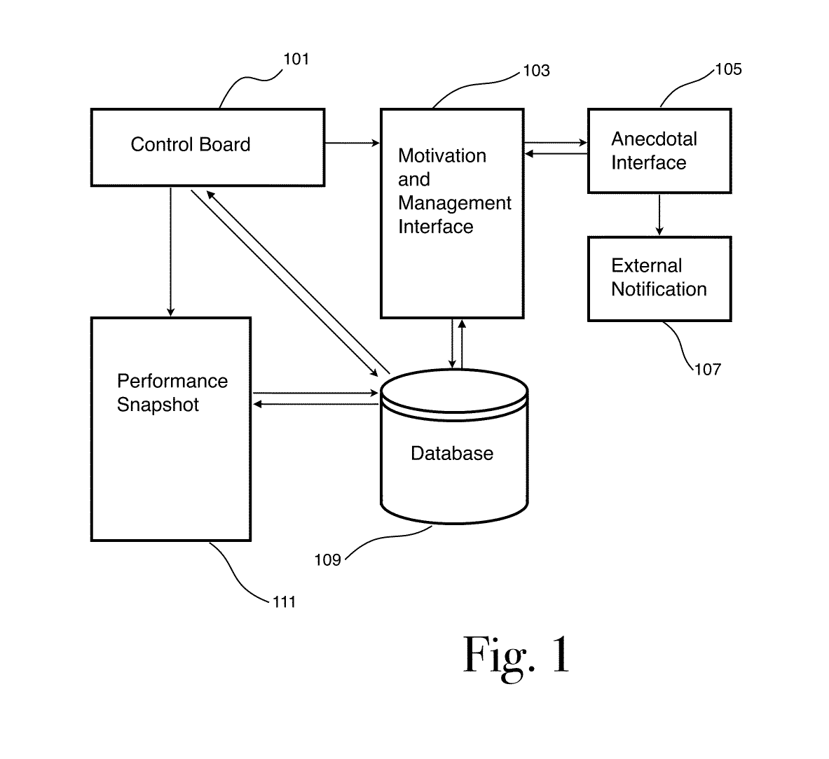

FIG. 1 illustrates a high level overview of the major components of the preferred embodiment. The major interface components include the Control Board 101, the Motivation and Management Interface 103, the Anecdotal Interface 105 with external notification 107 system, and various types of data displays 111. A database 109 is provided to relate student performance attributes associated with students, as well as information associated with particular teachers and classes.

### Overview of Major Components

Database. A database 109 is provided. The database relates students to academic and behavior attributes. Acceptable database software includes, without limitation, Microsoft Access, SQL or XML databases. The database may be local, networked or cloud based (that is, stored in a remote computer system and accessed locally). Likewise, the interactive display features may be accessed 213 locally, via local network or by Internet. Different aspects of the system may be particularly useful to teachers, school administrators 215, students 217 and to the parents 219 of students.

The Control Board 201 is the main interface used for lesson preparation. A teacher may use the Control Board interface to navigate, update and archive student data 221 in the database, including the student roster 239 for a particular class and the teachers preferred list 245 of default “anecdotal” behaviors. When the lesson data is ready, a “start” button loads the data into a student-facing “Motivation and Management Interface” 223.

A Lower Control Board 203 section provides for a variety of data entry 205. The Lower Control Board may be used to input Participation, Assessment, Homework and weighting information into the database.

The Motivation and Management Interface 223 is the main interface used during a lesson. It displays student data in a format that is useful for class. The displayed data includes student names, participation score, homework score, attendance score and overall average score. The Motivation and Management Interface 223 also allows a teacher to update student data in real time. For example, the interface may be used to deduct a participation point from a disruptive student. The interface will immediately display the results.

The Anecdotal Interface 227 allows teachers to input more detailed student behavior information in real time. During a class, the anecdotal interface may be used to select a student, and then quickly select a behavior to associate with a modification of a student's participation score. The information 229 may be sent to parents, counselors, administrators or others 231 via a networked communication medium 233.

The Name Selector 225 feature selects the name of a student in the class. For example, it may randomly select a student's name to answer a question posed by the teacher. It may also select a name based on student behavior data, participation data, homework data, or other data related to a student.

The Assessment Interface 237 is used to record student assessment information, and to easily update 241 assessment information when a student makes up a missed exam. The Homework Interface 235 is used to record student homework assignment information and to update 243 the homework information when a student turns in a missing homework assignment.

The Control Board may also be used to bring up a variety of information displays, including a Teacher Statistics display 209, performance snapshot 207, and the Grade Guide Interface 211. The Grade Guide Interface 211 allows students to review their predicted grades based on current assignment and behavior information.

### Control Board

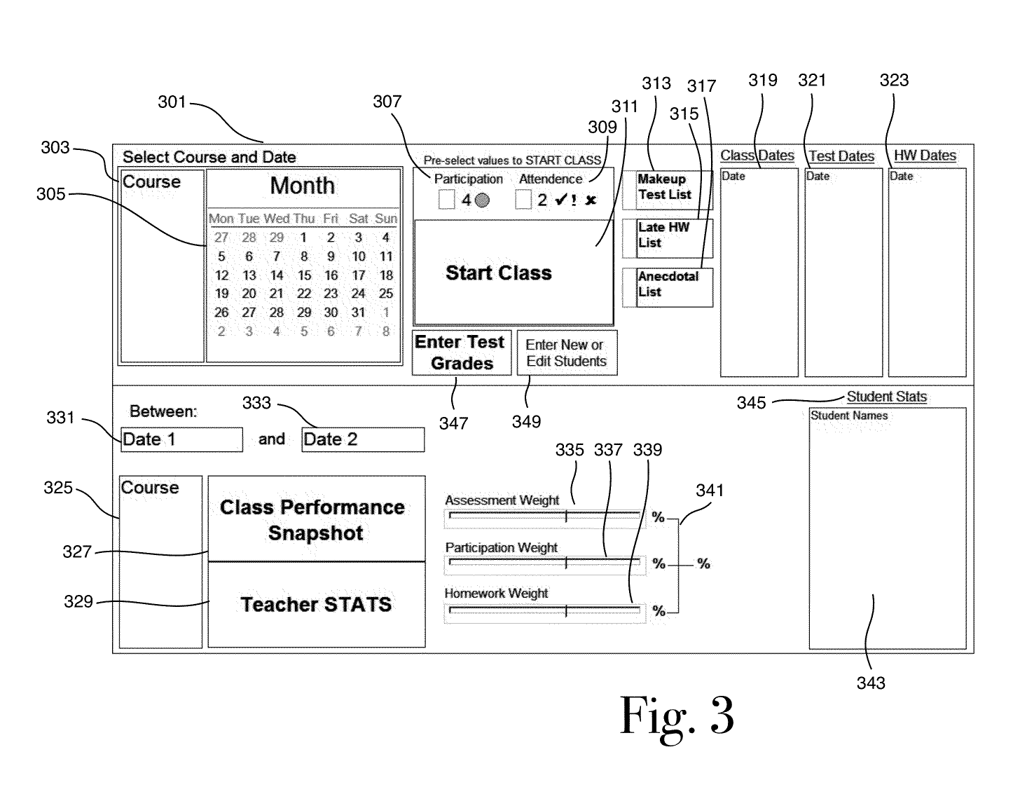

FIG. 3 illustrates an example of the Control Board interface 301. A first box 303 displays the classes taught by the user. Classes are given a unique database ID number, and may also have a naming scheme relevant to the students and teacher, for example “Fourth Period Social Studies.” A second box 305 displays a calendar. The user may use these tools to select a date and class, and to enter, edit or review the database information associated with that date and class. The system preferably takes the current date as input, and defaults to displaying the next scheduled class, as that is the class the teacher is most likely to review.

Initial values are selected for student participation 307 and attendance 309 data. These values are arbitrary number from which points may be added or deducted. For example, student participation points may be set to default to 4, and student attendance points may be set to default to 2. Students will begin class with these values, and the teacher may increase or decrease the values based on student behavior. Since students feel they possess something tangible (in this example, 4 “participation points”), and since giving up a possession has a greater psychological impact than not receiving a possession, students tend to work harder to maintain default point level.

An Enter Test Grade button 347 is provided to access the assessment interface 601. A student data entry button 349 is provided to update the class roster information.

A series of dropdown menus 313, 315, 317 are provided in the control board. These menus display Makeup Exam information 313, Late Homework information 315, and “Anecdotal” behavior information 317.

Upon selecting the Makeup-Exam dropdown box 313, the system accesses the database, and provides from the database a list of the names of students who have missed exams (and therefore need to make up and an exam). This list of student names is displayed in the dropdown box list in the Control Board interface. Upon selecting a student from the Makeup-Exam list 313, the system provides further information from the database about the student. This information preferably includes a list of the exams the student has missed and not yet taken.

When a student completes a makeup exam, the exam details may be updated directly from this Makeup Exam dialogue. The system provides for faster navigation by limiting the list student names to students who have missed an exam (rather than a list of all students).

Upon selecting the late homework dropdown box 315, the system accesses the database, and provides from the database a list of the names of students who have failed to hand in homework assignments. This list of student names is displayed in the late homework dropdown box list in the control board interface. Upon selecting a student from the Late Homework list, the system provides further information from the database about the student. This information preferably includes a list of the homework assignments the student has not yet turned in to the teacher.

When a student completes a late homework assignment, the teacher can use this dialogue to quickly select the appropriate student and update their homework assignment details. Since the list is limited to students who have missed an assignment, rather than a list of all students in the class, the system allows for faster navigation to the appropriate student. Upon selecting a student from the Late Homework list, and selecting a missed homework assignment, and marking that assignment as completed, the database is updated to reflect the student's completion of that homework. The system preferably accepts a grade associated with the homework and updates the database accordingly. The system may also automatically reduce the homework grade in proportion to the length of delay between the homework deadline and actual receipt.

Upon selecting the Anecdotal List dropdown box 317, the system accesses the database, and provides from the database a list of the names of students who have had behavior noted in previous classes.

This list of student names is displayed in the Anecdotal dropdown box list in the Control Board Interface. Upon selecting a student from the Anecdotal list, the system provides further information from the database about the student. Selecting the name of a student from the Anecdotal list displays further information, including the types of behavior noted and the dates of the behavior.

The Control Board Interface further includes a list of Class Dates 319, a list of Test Dates 321, and a List of Homework Dates 323.

The lower portion of the Control Board displays information relevant to the class, and allows the user to access a variety of information about individual student performance and aggregate student performance.

A date range is selected using two dropdown boxes 331, 333. Next, a list of the user's courses is provided in the course box 325.

Grade weighting sliders 335, 337, 339 allow the teacher to adjust the weighting of different class components. The total weighting 341 preferably adds up to 100%. For example, assessment 335, participation 337 and homework 339 weighting may be adjusted by interrelated sliders. Adjusting the grade weighting sliders changes weighting used in the algorithm that takes student assessment, homework and behavior data from the database as input, calculates the final grade, and provides the final grade as output.

The student statistical display box 345 provides a list of student names 343 from the database. The provided student names are associated with the selected class from the course box 325. Selecting a student name causes the system to display a student stats window providing performance information associated with the selected student. This data may include their participation data, attendance data, behavior data, and exam/assessment data. A class snapshot button 327 is provided to access a Class Snapshot interface. A Teacher Stats button 329 is provided to access a Teacher Stats interface. This interface provides database data relating to the aggregate performance of a particular class. It may be useful for a teacher to compare student progress across classes to compare different teaching techniques or other variables that may affect teaching performance.

The Start Class button 311 causes the system to display the Motivation and Management Interface 401. The Motivation and Management Interface is the front-end interface used during a lesson.

### Motivation and Management Interface

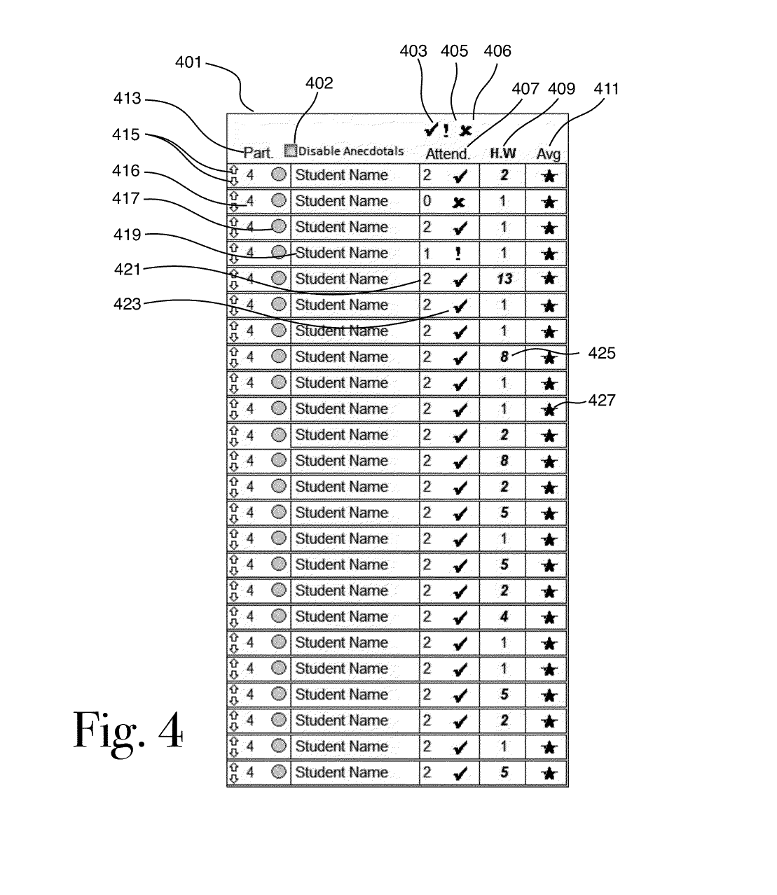

FIG. 4 illustrates an example of the Motivation and Management Interface. The Motivation and Management Interface 401 provides a system of social behavior regulation.

Students tend to model each other's behavior. When a student's positive behavior is highlighted and properly rewarded, other students will model this behavior. The Motivation and Management Interface highlights and provides real-time feedback to students about their behavior. This information may be numerical, and may also be color-coded to facilitate recognition and patterns.

The Motivation and Management Interface 401 provides an intuitive interface for selecting a student and adjusting their relevant data. The Motivation and Management Interface is “student facing.” That is, it is displayed to the students during class.

The Motivation and Management Interface 401 is preferably dockable to edge of a display 803. The narrow layout allows the remainder 807 of the display panel to remain available for providing substantive lesson or demonstration material.

The Motivation and Management Interface 401 displays a list of students in a class. A Participation score column 413 is provided next to the student's names 419. Participation scores 416 preferably include both a numerical score and a color-coded score symbol 417. For example, a score of 4 is linked to a green light, 3 to a yellow, and 2 or below to a red light. This visualization provides students immediately recognizable graphical information, and provides teachers with an easy means of assessing overall class behavior scores.

Up and down arrows 415 are provided next to the participation score 419. The arrows 415 are clickable buttons. Clicking the up arrow causes the Motivation and Management Interface 401 to access the database and incrementally increase the associated student's participation score for the current class. Likewise, clicking the down arrow causes an incremental reduction. When the scores are adjusted, an Anecdotal Register box 501 is opened. The Anecdotal interface screen can be disabled with the Disable Anecdotals checkbox 402. With this box 402 checked, participation scores can be adjusted with associating the incremental change with a particular behavior.

Attendance scores 421 are provided next to student names 419. In the preferred embodiment, the scores are 0 for absent, 1 for late and 2 for present. A graphical symbol 423 may be linked to the numerical score. For example, green check 403 for present, yellow bang 405 (exclamation point) for late, and red X 406 for absent. As the teacher takes attendance, he or she may click an item in the attendance column 407 to incrementally change the student's attendance score 421.

A column for missing homework 409 is provided next to the student's names 419. The missing homework column 409 provides a tally 425 of the missing homework assignments associated with a student for the current class.

Finally, a column summarizing student scores 411 is provided. A color-coded symbol 427 linked to the weighted average output from the weighted average algorithm is displayed next to the associated student. For example, a green star for above average, a yellow star for average and a red star for below average.

In addition to use in lectures, the system is particularly useful during interactive group activities. Students can work on projects in small groups, while the teacher uses the interface to manage participation.

### Anecdotal Interface

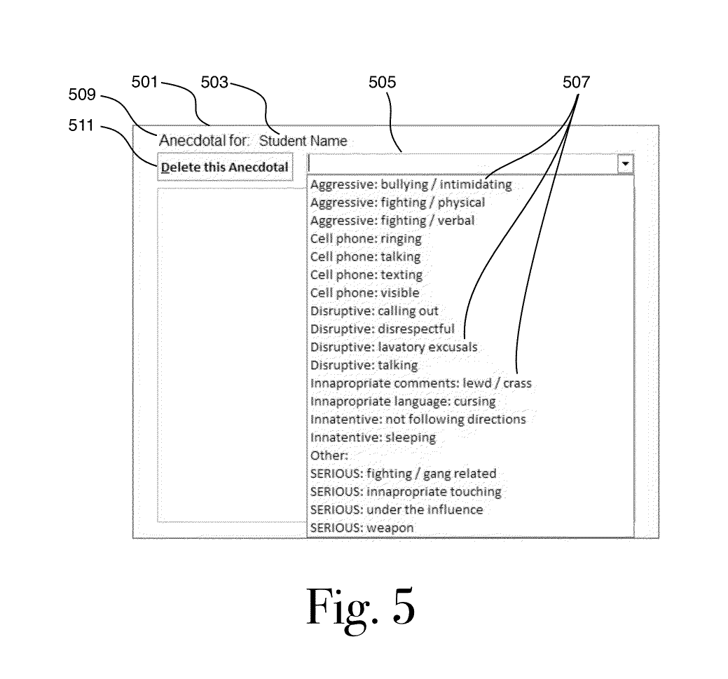

FIG. 5 illustrates an example of the Anecdotal Interface 501. The Anecdotal Interface 501 allows teachers to note disruptive student behavior without interrupting a lesson.

When a student's participation score 417 is adjusted 415 in the Motivation and Management Interface 401, the system provides an Anecdotal Interface display 501. The Anecdotal Interface preferably provides a title 509 and the name of the student 503 that is having his or her participation score adjusted. This display 501 includes a list 505 of selectable contextual activities 507 that may be associated with the change in participation credit. For example, when a point is deducted, it may be associated with “cell phone: texting.” An option for deleting 511 a mistakenly input anecdotal is provided.

The Anecdotal Interface may include an audio component. For example, when a participation point is deducted, a sound is played to notify the student. This is especially relevant for deducting points for failure to pay attention to a lesson (for example, if a student is texting, they may not otherwise notice a point has been deducted from their participation score). In addition, the notification sound does not come from the teacher. The teacher remains free to continue the lesson with minimal interruption of lesson “flow.”

In another embodiment, the anecdotal interface also notifies parents, guardians or counselors of the student's disruptive behavior. For example, the database includes a list of parents, guardians, counselors or similar adults associated with a particular student. A telephone number, email address or social media account is associated with each adult. When a student's behavior is noted in the Anecdotal Interface, the system automatically notifies the associated adult with a pre-packaged email, SMS message, twitter message or similar electronic communication. The message may state, for example, “Your son, John Doe, has just lost a participation point for fighting in class.”

This immediate communication system keeps parents and teachers on the same page with regards to student performance. When appropriately and immediately notified about misbehavior, parents can work with teachers on a daily basis to improve a student's behavior and class performance. Furthermore, the student may be less inclined to misbehave if he or she knows that her parents will be immediately notified.

### Assessment Interface

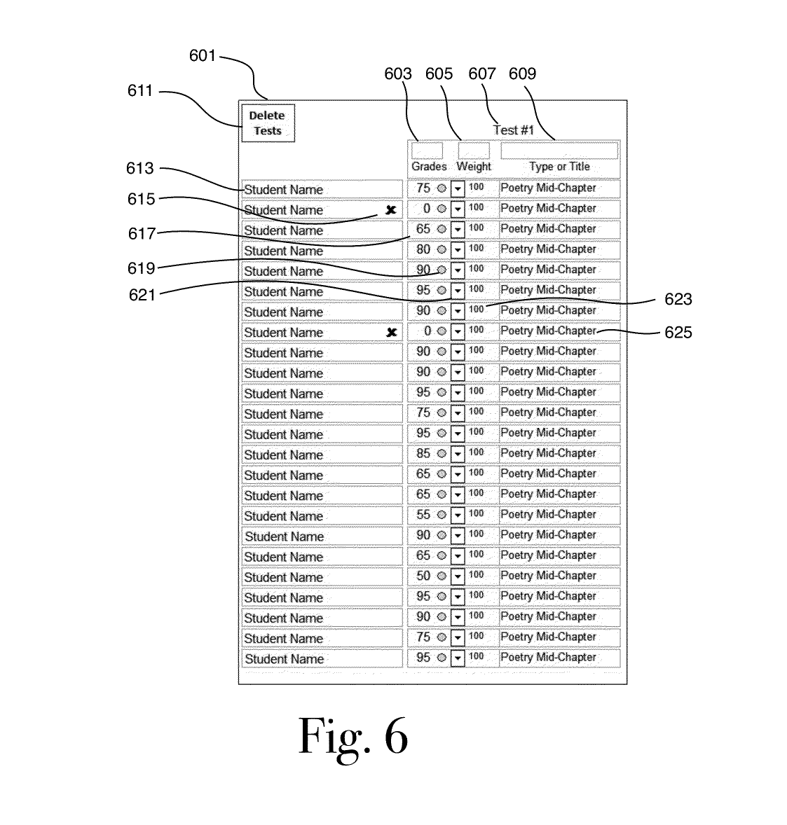

FIG. 6 illustrates an example of the Assessment Interface 601. From this interface, the teacher may enter assessment information, preferably including, assessment type 609, title 607, weight 605, and grade 603.

The Assessment Interface 601 provides from the database a list of the student names 613 associated with a particular class. The teacher may associate an assessment with a name 625 and a weight 623 for grading purposes. A Delete Tests button 611 is provided to remove test data from the database.

For each student 613, the assessment may be associated with an assessment grade 617. The assessment grade 617 preferably includes both a numerical component and linked symbolic component 619. If a student is absent or unable to participate in the assessment, a notification 615 will be associated with the student (for example, a red X icon could appear next to their name).

### Homework Interface

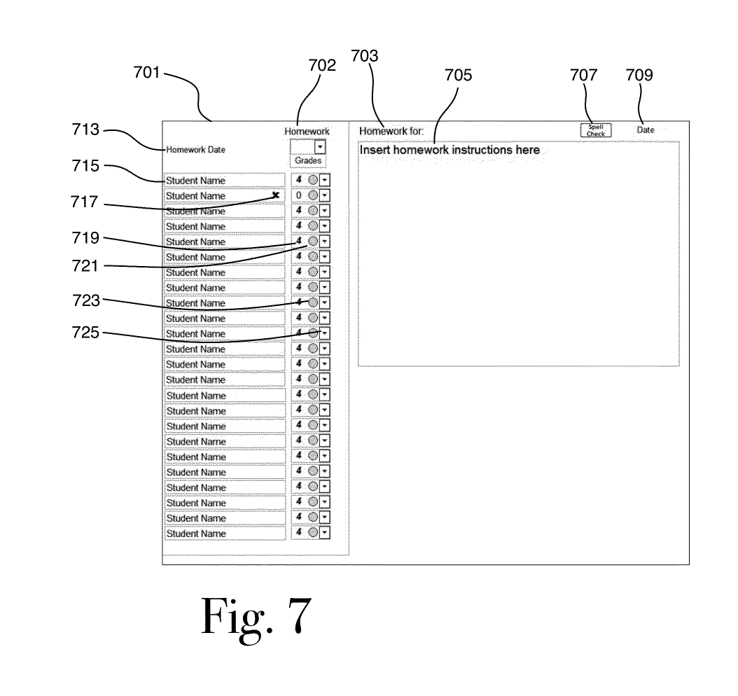

FIG. 7 illustrates an example of the Homework Interface 701. From the Homework Interface 701, the teacher may create a homework assignment entry in the database and associate the assignment entry with a title, weight for grading purposes.

The Homework Interface includes a dropdown box 702 to select a particular homework assignment, and provides the date 713 associated with the assignment. The Homework Interface 701 provides list of the student names 715 from the database for a particular class. For each student 715 in the database, the assignment may be associated with an assignment grade 719. The assessment grade preferably includes a numerical component 719 and a linked symbolic component 721. If a student has not completed the assignment, a notification 717 will be associated with the student (for example, a red X icon appears next to the student's name 715). A dropdown box 725 is provided to facilitate entry of homework data.

In addition to the student list 715, a homework setup interface is provided. This portion of the Homework Interface 701 includes a title 703 identifying the class with which the homework associated. The due date 709 is preferably provided. The teacher may input the homework assignment instructions 705 directly into the Homework Interface. A spell check option 707 is preferably provided.

### Name Selector

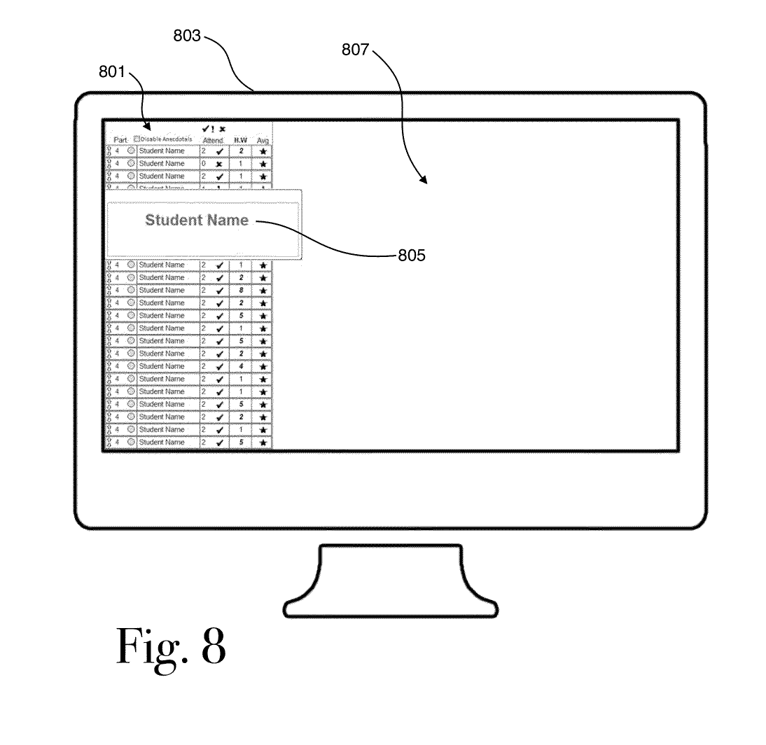

FIG. 8 illustrates an example of the Name Selector feature 801 of the Motivation and Management Interface 401 while docked on the edge of a display 803. The name selector is activated from the Motivation and Management Interface 401. In the preferred embodiment, the name selector is activated by clicking on any student name 419. When activated, the system selects a name 805 from the list of students present in the class.

The teacher may then call upon the selected student to answer a question, perform a task or otherwise participate in the class. Automated student selection avoids a number of common problems. For example, many teachers tend to favor stronger students for participation, because they know it will be faster and easier than calling on other students. An automated system avoids this problem.

In one embodiment, the student Name Selector 801 selects a student at random. In another embodiment, the Name Selector accesses student information from the database, processes the student information and selects an appropriate student based on the output of a selection algorithm. The algorithm may consider, for example, past participation points (where low participation score results in student being selected more frequently), homework scores or recent test scores. Low test scores may indicate a student needs closer academic supervision, and therefore result in more frequent selection from the student name selector algorithm. Since student participation and behavior is tracked in real-time, the system can integrate this information into a weighted algorithm for selecting a student.

### Grade Guide Interface

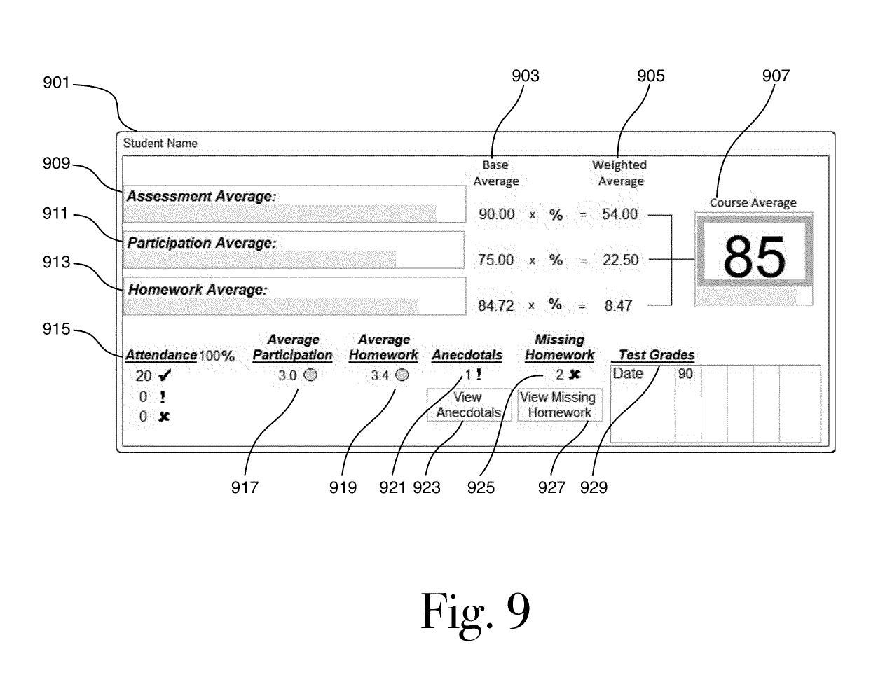

FIG. 9 illustrates an example of the Grade Guide Interface or “Grade Predictor” 901. The Grade Guide Interface is directed towards individual students.

It accesses the student database and displays a student's current academic and participation data. Student database information is displayed in the form of progress bars for assessments 909, participation 911, and homework 913. The Interface 901 provides the students raw average 903 and the weighted average 905 for each of the assessment, participation and homework scores. The student's predicted end-of-term grade 907 is displayed.

Displaying the raw average as well as the weighted average helps identify the student's strengths and weaknesses. For example, it may help identify whether the student struggles with multiple choice tests or with turning in homework.

The student's attendance data 915, participation average 917, homework average, 919 are also provided in numerical and symbolic forms. Anecdotal data 921 is displayed along with a button 923 to display further detailed anecdotal information from the database. Missing homework data 925 is displayed along with a button 927 to display further detailed missing homework information from the database. The grades of individual tests and assessments 929 are also displayed to the student.

A predicted course average 907 is displayed. The user may also input a desired final grade. Upon entering the desired goal, the system takes the current student information and the remaining grading opportunities as input, and determines whether the goal is achievable. If the goal is achievable, the system provides as output the scores the student will need to achieve to attain his or her desired goal. This system helps the student achieve goals by breaking long term goal down into smaller chunks.

### Teacher Stat Interface

The Teacher Statistics interface provides tools for the teacher. The interface lists the teacher's courses and provides a breakdown of individual course performance. This breakdown may include the overall average of all students for the entire course.

In addition to numerical indicators of course performance, visual indicators are provided. These colors and shapes facilitate quick identification of areas of strong or weak performance.

The courses are ordered according to performance. The teacher can compare class performance as a whole. This may be helpful in identifying particularly effective educational methods or biases for or against a particular class.

Although embodiments have been described in detail, the invention is not limited to the details provided. There are many alternative ways of implementing the invention. The disclosed embodiments are illustrative, not restrictive.

What is claimed is:

1. A method for managing a class of students comprising:
a. receiving student names from a database,
b. associating the student names with student participation scores,
c. providing student names associated with participation scores to a display,
d. receiving an incremental adjustment to the student participation data associated with a student name,
e. providing a selectable list of behaviors associated with the direction of the incremental adjustment,
f. receiving, as input, a selection from the list of behaviors,
g. associating the selected behavior with the incremental adjustment to the student participation data, and
h. providing the student names associated with the newly adjusted participation data to the display.

2. The method of claim 1, wherein the selectable list of behaviors includes behaviors selected from the list of: fighting, bullying, verbal abuse, phone ringing, phone talking, texting, speaking out of turn, disrespectful behavior, excessive lavatory excusals, inappropriate comments, lewd comments, cursing, inattentive behavior, sleeping, serious fighting, gang related fighting, serious inappropriate touching, drugs, alcohol, and weapon.

3. The method of claim 1, further comprising,
a. providing the behavior data adjustment and associated behavior to a third party via electronic communications.

4. The method of claim 3 where the electronic communication is either email, sms, text message, telephone call with pre-recorded message, Skype®, Twitter®, Facebook®, or other social network.

5. The method of claim 1, wherein,
a. the student names are provided to the display along with a plurality of incremental adjustment buttons,
b. each button is associated with a student name, and
c. activation of a button by a user provides the incremental adjustment input.

6. The method of claim 5, wherein the student names, and participation data are provided to the display in a dockable window that leaves at least half of the display available for other uses.

7. The method of claim 1, wherein, the student participation scores are associated with visualization icons.

8. The method of claim 7 wherein, the visualization icons include a green circle, a yellow circle, and a red circle.

9. The method of claim 1, further comprising, providing a sound effect when a student participation score is adjusted, wherein the sound effect is loud enough to notify an inattentive student, but not so loud that it distracts an attentive student from the lesson.

10. The method of claim 1, further comprising an automated student selector, wherein the automated student selector,
a. receives a list of student names from the database,
b. selects a student name from the list at random, and
c. provides the selected name as output.

11. The method of claim 1, further comprising an automated student selector, wherein the automated student selector,
a. receives a list of student names and associated student participation scores and homework completion data and from the database,
b. selects a student name from the list according to a weighted selection algorithm that selects students with low student participation scores or low homework completion scores more frequently than other students, and
c. provides the selected name as output.

12. The method of claim 1, further comprising,
a. providing an interactive data-input screen with intuitive left-to-right fields, wherein,
b. a first field includes a selectable list of courses,
c. a second field to the right of the first includes a selectable list of dates,
d. a third field to the right of the second displays student data associated with missed examinations, late homework assignments and anecdotal behavior,
e. a fourth field to the right of the third includes a selectable list of class dates, examination dates, and homework dates.

13. The method of claim 1, further comprising,
a. providing an interactive homework interface,
b. receiving a homework assignment,
c. receiving a grade weighting associated with the homework assignment,
d. receiving grade input associated with the homework assignment and with a student,
e. identifying the students for whom a grade has not been recorded for the homework assignment,
f. providing the names of the students for whom a grade has not been recorded for the homework assignment.

14. The method of claim 1, further comprising,
a. providing an interactive grade guide interface,
b. receiving a student's grade data,
c. providing the student's grade data in the grade guide interface, wherein the data is presented in a plurality of adjustable sliders,
d. receiving a student's desired final grade,
e. calculating the future examination and homework grades required to earn the adjusted final grade, and
f. providing the calculated grade information to the student.

15. A computer system having a display and computer-readable storage medium with computer program logic embodied therein for managing a class of students, comprising:
a. a database containing a plurality of student names associated with assessment data, participation scores, behavior data, attendance data and a final grade, and
b. the display presents a list of student names associated with a participation score, attendance data and homework data, and
c. the system receives incremental participation score adjustment data for a student, and
d. the system updates the participation score for that student in the database, and causes the display to present the updated participation score.

16. The computer system of claim 15 wherein, the incremental decrease of a student's participation score causes the display to present a selectable list of inappropriate behaviors.

17. The computer system of claim 15 wherein,
a. the incremental increase of a student's participation score causes the display to present a selectable list of commendable behaviors, and
b. the incremental decrease of a student's participation score causes the display to present a selectable list of inappropriate behaviors.

18. The computer system of claim 16, wherein the selectable list of inappropriate behaviors includes items selected from the list of: fighting, bullying, verbal abuse, phone ringing, phone talking, texting, speaking out of turn, disrespectful behavior, excessive lavatory excusals, inappropriate comments, lewd comments, cursing, inattentive behavior, sleeping, serious fighting, gang related fighting, serious inappropriate touching, drugs, alcohol, and weapon.

19. The computer system of claim 15 further comprising a network connection, wherein,
a. the database associates at least one student with an adult,
b. the adult is associated with an address for the receipt of electronic communications,
c. if a student is associated with an adult, and the student's behavior score is adjusted during a class, the adjustment data and associated behavior is sent over the network connection to the adult.

20. The computer system of claim 19, wherein the address for the receipt of electronic communications is an email address, telephone number, Skype® account, Twitter® account, Facebook® account, or other social network account capable of receiving electronic communications.

21. The computer system of claim 15 further comprising a speaker, and wherein, the computer system causes the speaker to play a sound effect when a student participation score is adjusted.

22. The computer system of claim 15, further comprising an automated student selector, wherein
a. the automated student selector receives a list of student names from the database,
b. selects a student name from the list at random, and
c. provides the selected name to the display.

23. The computer system of claim 15, further comprising an automated student selector, wherein,
a. the automated student selector receives a list of student names and associated student participation scores and homework completion data and from the database,
b. selects a student name from the list according to a weighted selection algorithm that selects students with low student participation scores or low homework completion scores more frequently, and
c. provides the selected name to the display.
